(19) United States
(12) Patent Application Publication
(10) Pub. No.: US 2018/0251336 A1
(43) Pub. Date: Sep. 6, 2018

(54) ELEVATOR BRAKE

(71) Applicants: Manuel Garcia-Canales, Leganes (Madrid) (ES); Otis Elevator Company, Farmington, CT (US)

(72) Inventor: Manuel Garcia-Canales, Leganes (Madrid) (ES)

(21) Appl. No.: 15/756,687

(22) PCT Filed: Sep. 3, 2015
(86) PCT No.: PCT/EP2015/070134

§ 371 Date: Mar. 1, 2018

(51) Int. Cl. B66B 1/36; B66B 9/00; B66B 1/32; F16D 55/36; F16D 65/18; B66D 5/14; B66D 5/30

(52) U.S. Cl. CPC B66B 1/36; B66B 9/00; B66B 1/32; F16D 2121/22; F16D 65/186; B66D 5/14; B66D 5/30; F16D 55/36

(57) ABSTRACT

An elevator brake (50) comprises at least one first braking element (58, 58a, 58b) and at least one second breaking element (60, 60a) extending parallel to each other orthogonally to a common axial direction and being movable with respect to each other in said axial direction; and at least two actuators (70), which are arranged in a circumferential direction and configured for moving at least one of the first and second braking elements (58, 58a, 58b, 60, 60a) in the axial direction.

### The invention relates to an elevator brake.

Elevators are usually provided with brakes which are designed for use in normal operation of the elevator, for example to hold an elevator car in place when it stops at a landing; and which are designed for use in emergency situations such as stopping the elevator car and/or counterweight from plunging into the hoistway pit. The capacity, i.e. the maximum holding force, and in consequence the design of these elevator brakes depends on the size of the elevator car, in particular on its maximum weight or on the maximum difference in weight between the elevator car and the counterweight, respectively.

It would be beneficial to provide an improved elevator brake allowing to adjust its capacity by adapting a common brake design in order to employ similar brakes in different types of elevators. It also would be beneficial to provide a brake which may be engaged and disengaged progressively.

According to an exemplary embodiment of the invention, an elevator brake comprises at least one first braking element and at least one second braking element extending parallel to each other orthogonally to a common axial direction and being movable with respect to each other along said axial direction. The elevator brake further comprises at least two actuators arranged in a circumferential direction and configured for moving at least one of the first and second braking elements in the axial direction.

By varying the number of actuators employed, the capacity of the elevator brake may be adjusted to the actual needs. Thus, elevator brakes which are constituted from basically the same components but comprise different numbers of actuators may be used for different types of elevators. As a result, the components constituting the brake may be produced in large numbers at reduced costs. In addition, exemplary embodiments of the invention allow to provide a kit of components which may be modularly combined for forming a brake providing the capacity which is actually needed. As a result, the efforts and costs for individually designing a suitable brake for every type of elevator may be avoided.

A method of deactivating/releasing an elevator brake according to an exemplary embodiment of the invention comprises activating at least one of the actuators. The method in particular comprises activating at least one of the actuators in a first step and activating at least one additional actuator in a second step.

A method of activating an elevator brake according to an exemplary embodiment of the invention comprises deactivating at least one of the actuators. The method in particular comprises deactivating at least one of the actuators in a first step and deactivating at least one additional actuator in a second step.

By sequentially activating/deactivating the actuators of the brake, the braking force provided by the brake may be progressively decreased/increased in order to progressively disengage/engage the brake. Thus, an abrupt stopping of movement of the elevator car, which may be uncomfortable or even dangerous for the passengers residing inside the elevator car, may be avoided.

The invention is described in more detail with reference to the enclosed figures.

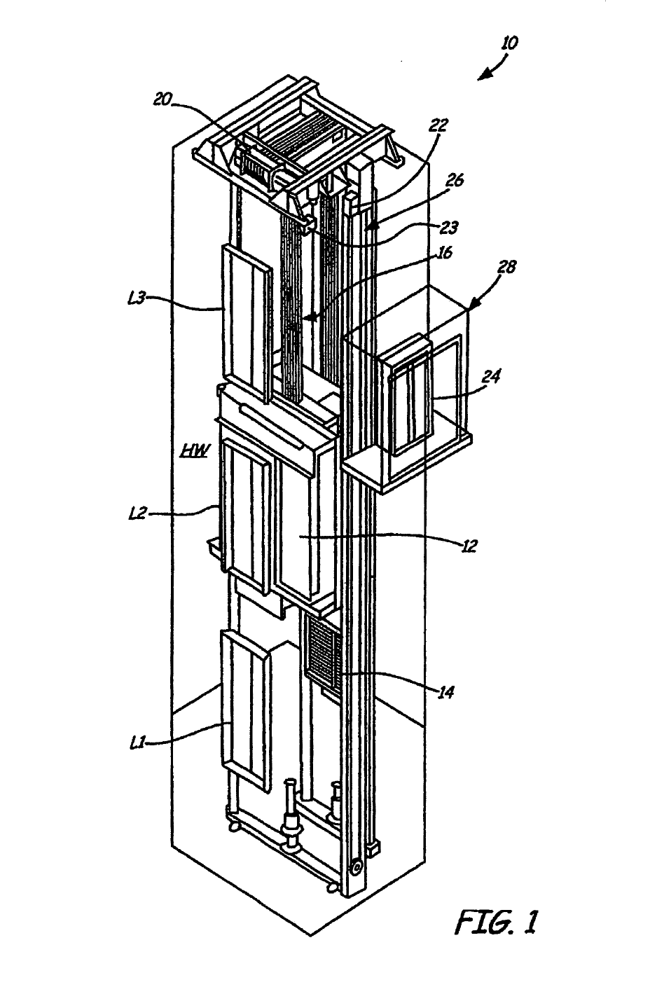

FIG. 1 illustrates a perspective view of an elevator system in which an elevator brake according to an exemplary embodiment of the invention may be employed.

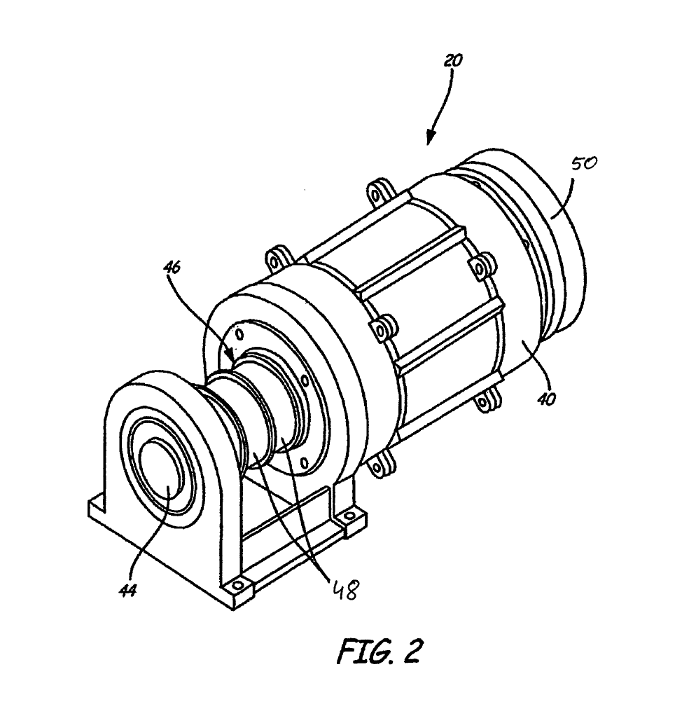

FIG. 2 is a perspective view of an elevator hoist machine which is configured for controlling the movement of the elevator car.

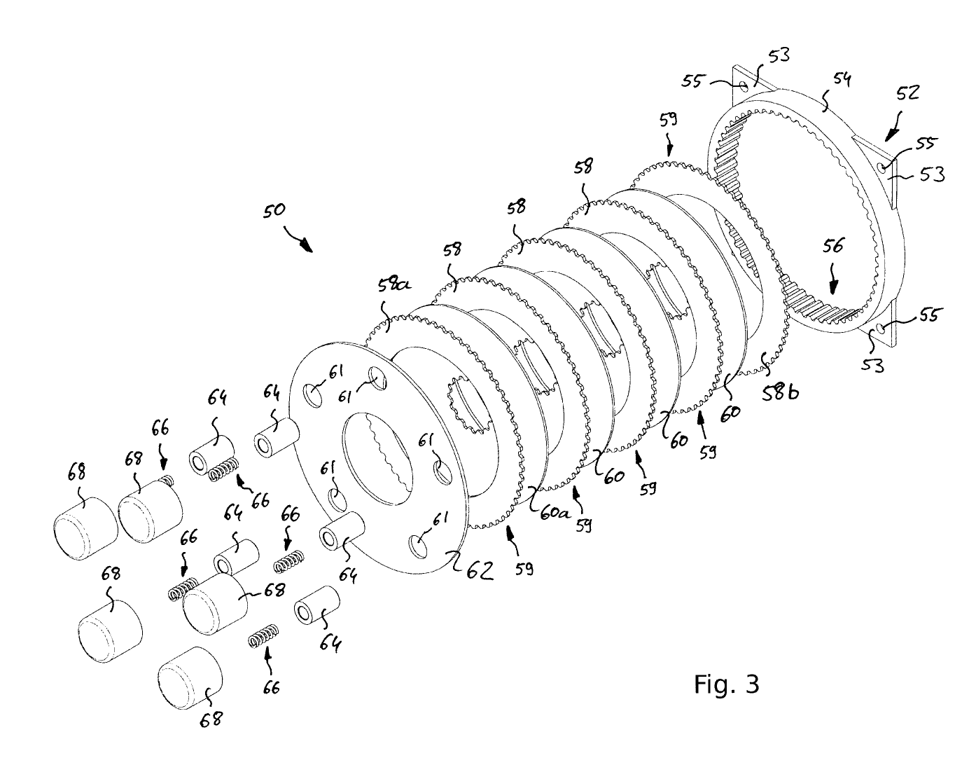

FIG. 3 shows a perspective explosive view of an elevator brake according to an exemplary embodiment of the invention.

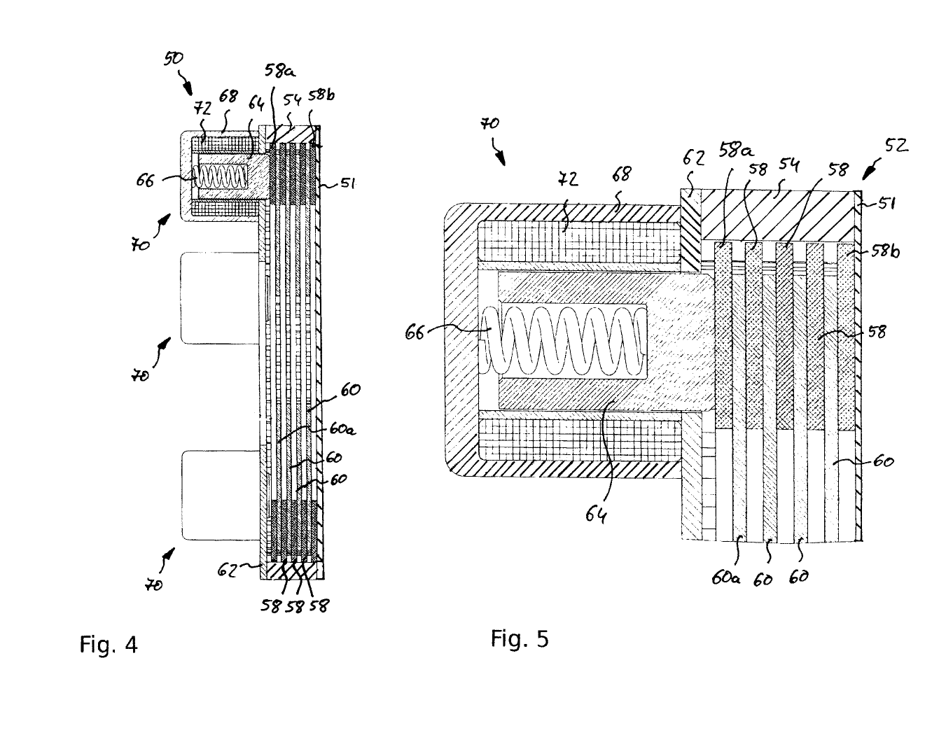

FIG. 4 illustrates a sectional view of the elevator brake shown in FIG. 3.

FIG. 5 shows an enlarged detail of the upper left portion of FIG. 4.

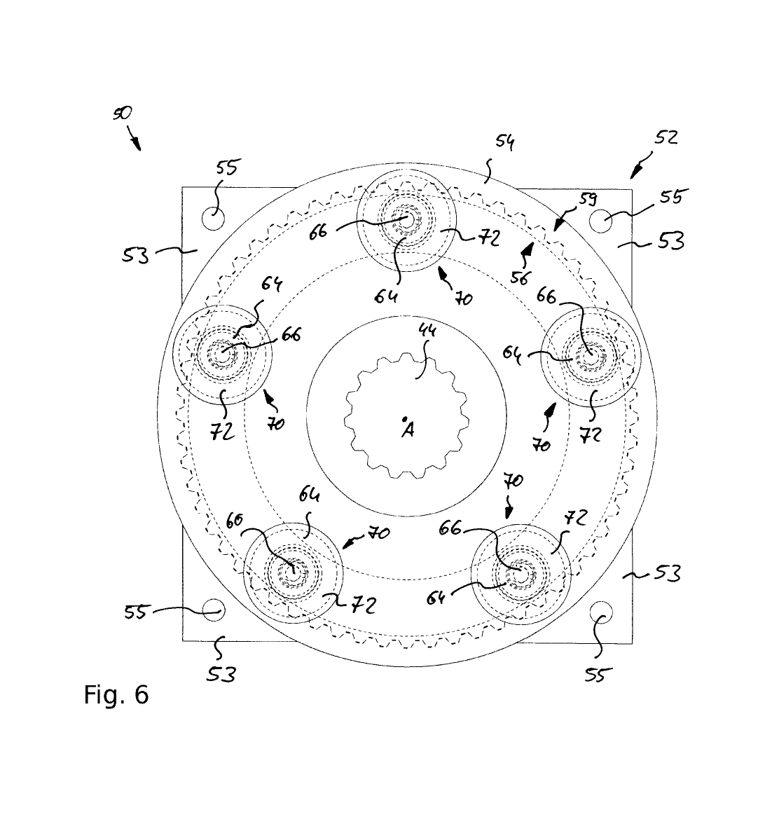

FIG. 6 shows a plane view of the front side of the elevator brake, i.e. a view from the left side of the configuration shown in FIGS. 3 to 5.

FIG. 1 is a perspective view of an exemplary embodiment of an elevator system 10 including an elevator car 12, a counterweight 14, a plurality of tension members 16, which may include ropes or belts, an elevator hoist machine 20, a position encoder 22, a limit switch 23, and a controller 24. The elevator car 12 and the counterweight 14 are connected by a plurality of tension members 16 and suspended in a hoistway HW including a plurality of landings L1, L2, and L3.

The elevator car 12 and the counterweight 14 are interconnected by the tension io members 16 to move concurrently and in opposite directions within the hoistway HW. The counterweight 14 balances the load of the elevator car 12 and facilitates the movement of the elevator car 12. In one embodiment, the counterweight 14 has a mass approximately equal to the mass of the elevator car 12 plus one half of the maximum rated load of the elevator car 12. The tension members 16 may include steel cables or coated steel belts. The tension members 16 engage the elevator hoist machine 20, which controls the movement between the elevator car 12 and the counterweight 14.

A position encoder 22 is mounted on an upper sheave of an elevator speed governor system 26. Alternatively, the position encoder 22 may be mounted directly on the drive shaft 44 (see FIG. 2) of the elevator hoist machine 20. The position encoder 22 provides signals related to the position of the elevator car 12 within hoistway HW to a controller 24. When the elevator speed governor system 26 signals a speed over a predetermined limit, an elevator brake 50 is engaged to stop the movement of the elevator car 12.

A limit switch 23 is actuated by a cam (not shown) that rides with the elevator car 12 to insure that the elevator car 12 does not run into the overhead structure including the elevator hoist machine 20. The elevator 10 may include additional limit switches to prevent the elevator car 12 from running into the top or bottom of the hoistway HW. The limit switch 23 is actuated when the elevator car 12 moves upwardly past the top landing L3. The limit switch 23 may be a mechanically actuated lever or switch, or an electrical switch that is actuated when the cam comes into electrical contact with the limit switch 23. When actuated by the elevator car 12, the limit switch 23 provides a signal to the controller 24 to remove any power to the motor 40 preventing any further travel in either direction.

The controller 24, which is located in a controller room 28 in the hoistway HW, provides signals to the elevator hoist machine 20 for controlling acceleration, deceleration, leveling, and stopping of the elevator car 12. The controller 24 also receives signals from the position encoder 22 and the limit switch 23.

FIG. 2 is a perspective view of the elevator hoist machine 20 for controlling the movement of the elevator car 12 and the counterweight 14. The elevator hoist machine 20 includes a motor 40, an elevator brake 50, a rotating drive shaft 44, and a sheave 46. The drive shaft 44 projects from the motor 40, and the sheave 46 is fixedly disposed on the drive shaft 44. The elevator brake 50 is provided adjacent to the motor 40 at the end of the drive shaft 44 opposite from the sheave 46. Alternatively, the elevator brake 50 may be located on the side of the sheave 46 opposite from the motor 40. The sheave 46 includes traction surfaces 48 for mechanically engaging with the tension members 16, which are not shown in FIG. 2.

The drive shaft 44 is driven by the motor 40 causing the sheave 46 to rotate. Due to friction between the tension members 16 and the traction surfaces 48, rotation of the sheave 46 causes a linear movement of the elevator car 12 and the counterweight 14 along the hoistway HW. The motor 40 drives the drive shaft 44 based on signals received from the controller 24. The magnitude and direction of force (i.e., torque) exerted by the motor 40 on the tension members 16 controls the speed and direction of the elevator car 12, as well as the acceleration and deceleration of the elevator car 12.

When the elevator car 12 is stopped, the elevator brake 50 engages the drive shaft 44 to prevent any further movement of the elevator car 12. When the elevator brake 50 is engaged, a torque is exerted on the elevator brake 50 that is caused by the relative weights of the elevator car 12 and the counterweight 14. In particular, if the overall mass of the elevator car 12 (i.e., the mass of the elevator car 12 plus the load therein) is greater than the mass of the counterweight 14, a torque in a first direction is exerted on the elevator brake 50. Conversely, if the mass of the counterweight 14 is greater than the overall mass of the elevator car 12, a torque in a second, opposite direction is exerted on the elevator brake 50.

FIG. 3 shows a perspective explosive view of an elevator brake 50 according to an exemplary embodiment of the invention. FIG. 4 illustrates a sectional view of said elevator brake 50 and FIG. 5 shows an enlarged view of the upper left portion of FIG. 4 including an actuator 70.

The elevator brake 50 comprises a housing 52 having a tubular portion 54 and four external fastening lugs 53, which are attached to the outer periphery of the tubular portion 54. Each of the external fastening lugs 53 comprises a fastening opening 55 for fixing the housing 52 to the structure of the elevator hoist machine 20 by appropriate fastening elements (not shown), e.g. bolts or screws, extending through the fastening openings 55.

Internal teeth 56 are formed on the inner circumference of the tubular portion 54. One (“rear”) side of the housing 52, i.e. the side shown on the right side of FIGS. 3 to 5, is terminated by a front plate 51, which may be part of the housing and which is shown in FIGS. 4 and 5, but not in FIG. 3.

The housing 52 houses first braking elements 58, 58a, 58b and second braking elements 60, 60a arranged alternately along an axis (not shown) of the tubular portion 54 of the housing 52. The second braking elements 60, 60a are respectively sandwiched between two of the first braking elements 58, 58a, 58b. In the exemplary embodiment shown in FIGS. 3 to 5, the first and second braking elements 58, 58a, 58b, 60, 60a are formed as circular disks and are oriented orthogonally to the axis of the tubular portion 54 of the housing 52.

The outer periphery of the first braking elements 58, 58a, 58b is provided with external teeth 59, which are configured for engaging with the internal teeth 56 provided at the housing 52. The engagement of the external teeth 59 of the first braking elements 58, 58a, 58b with the internal teeth 56 of the housing 52 provides a spline connection preventing any rotational motion of the first braking elements 58, 58a, 58b with respect to the housing 52.

The first and second braking elements 58, 58a, 58b, 60, 60a are respectively provided with a central opening allowing the drive shaft 44, which is not shown in FIGS. 3 to 5, to pass through in the axial direction.

The outer circumferences of the central openings of the second braking elements 60, 60a are provided with internal teeth. The internal teeth of the second braking elements 60, 60a are configured to engage with external teeth formed on the drive shaft 44 (not shown) extending through the openings providing a spline connection between the second braking elements 60, 60a and the drive shaft 44.

As a result, the second braking elements 60, 60a will rotate integrally with the drive shaft 44, whereas the first braking elements 58, 58a, 58b are not able to rotate as they are fixed to the housing 52 by means of the engaging internal and external teeth 56, 59.

The outermost first braking element 58a, which is shown on the left side of FIGS. 3 to 5, respectively, is covered by a cover plate 62 comprising a central opening allowing the drive shaft 44 (not shown) to pass through, and a plurality of circumferential openings 61, which are arranged on a virtual circle centered around the axis.

A movable rod 64 having a cylindrical shape passes through each of the circumferential openings 61, as it is illustrated in FIGS. 4 and 5, contacting the outermost first braking element 58a. In an alternative configuration, the outermost first braking element 58a may be omitted and the movable rods 64 will act on the outermost second braking element. In yet another embodiment, the movable rods 64 may act on an additional intermediate element (not shown), which may be arranged between the movable rods 64 and the first braking element 58a e.g. for manufacturing and/or assembly purposes.

Each rod 64 is elastically supported by means of an elastic element 66, for example a coil spring, on an actuator housing 68. The actuator housings 68 are fixed to the side of the cover plate 62 opposite to the first and second braking elements 58, 58a, 58b, 60, 60a.

In each actuator housing 68 an electric coil 72 is wound around the axis of the rod 64. The electric coil 72 is configured for moving the cylindrical rod 64 along its axis against the elastic force provided by the elastic element 66 (i.e. to the left side of FIGS. 3 to 5) by activating the electric coil 72. Thus, the pressure exerted by the rod 64 on the outermost first braking element 58a may be released by activating the electric coil 72.

In consequence, the rod 64, the elastic element 66, the electric coil 72 and the actuator housing 68 are components of an actuator 70 which operates as follows:

In case the electric coil 72 is not activated, i.e. no (or only a small) electric current is flowing through the electric coil 72, the elastic element 66 presses the rod 64 against the outermost first braking element 58a, which thereby is pressed against an adjacent second braking element 60, 60a, which in turn is pressed against the next first braking element 58, 58b and so on. In consequence, the sandwich structure, which is formed by the adjacent first and second braking elements 58, 58a, 58b, 60, 60a, is pressed together in the axial direction with the last (most right) first braking element 58b being pressed against the front plate 51 of the housing. In an alternative configuration, the last (most right) first braking element 58b is fixed (i.e. welded) to the tubular portion 54 of the housing 52 in order to prevent any motion in the axial direction.

The first braking elements 58, 58a, 58b are engaged with the internal teeth 56 of the housing 52, which prevents any rotational motion of the first braking elements 58, 58a, 58b. The second braking elements 60, 60a are fixed to the drive shaft 44 in a manner preventing any rotational movement between the second braking elements 60, 60a and the drive shaft 44. Therefore, the friction generated between abutting first and second braking elements 58, 58a, 58b, 60, 60a acts as a braking force on the drive shaft 44 slowing down or even inhibiting any rotational motion of the drive shaft 44 with respect to the housing 52.

In order to enhance the friction between abutting first and second braking elements 58, 58a, 58b, 60, 60a, at least one of the first and second braking elements 58, 58a, 58b, 60, 60a may comprise a material having a large frictional coefficient, and/or at least a portion of the first and second braking elements 58, 58a, 58b, 60, 60a contacting an adjacent braking element 58, 58a, 58b, 60, 60a may be laminated with a lining with a large frictional coefficient.

For releasing the elevator brake 50, the electric coils 72 of the actuators 70 are activated by flowing an electrical current therethrough. The electromagnetic force generated by the electric coils 72 moves the rods 64 against the force of the elastic elements 66 releasing the pressure exerted by the rods 64 onto the first and second braking elements 58, 58a, 58b, 60, 60a. This release of pressure reduces the frictional forces acting between the first and second braking elements 58, 58a, 58b, 60, 60a allowing the second braking elements 60, 60a and the drive shaft 44 connected with said second braking elements 60, 60a to rotate.

The strength of the braking force acting on the second braking elements 60, 60a and the drive shaft 44 may be adjusted by varying the electrical current flowing through the electric coils 72.

In particular, in a first step, only the electric coils 72 of some, but not all, of the actuators 70 may be activated in order to reduce the braking force acting on the second braking elements 60, 60a and the drive shaft 44 only partially.

In a second step, all actuators 70 will be activated by flowing an electrical current io through their respective electric coils 72 in order to allow a free movement of the second braking elements 60, 60a, the drive shaft 44 and the elevator car 12.

Similarly, the elevator brake 50 may be engaged smoothly by deactivating only some of the actuators 70 in a first step, and deactivating all actuators 70 in a second step.

Methods of activating/deactivating the elevator brake 50 may comprise additional intermediate steps in which more actuators 70 than in the first step but not all actuators 70 are deactivated/activated in order to activate/deactivate the elevator brake 50 even more smoothly.

Using a weight sensor (not shown), which is configured for detecting the actual weight of the elevator car 12, allows to activate only the number of actuators 70 which are actually needed for applying the torque required for the actual number of passengers residing inside the elevator car 12 instead of activating all actuators 70. In doing so, the braking torque can be adapted to the actual load and does not cause excessive deceleration, which may result in discomfort or even injuries of the passengers.

FIG. 6 shows a plane view of the front side of the elevator brake 50, i.e. a view from the left side of the configuration shown in FIGS. 3 to 5.

FIG. 6 in particular illustrates that the five actuators 70 are arranged in constant angular distances on a virtual circle centered on the central axis A of the elevator brake 50, which is identical with the central axis A of the drive shaft 44.

It is self-evident that the number of five actuators 70 is only exemplary and that the number of actuators 70, which are employed in a specific embodiment of an elevator brake 50, may be varied for adjusting the capacity of the elevator brake 50, i.e. the maximum braking force provided by the respective elevator brake, to the actual needs.

In other words, in case of an elevator system 10 comprising a large elevator car 12, in which a large braking force is necessary, the elevator brake 50 may be equipped with a large number of actuators 70, which, in combination, are capable of providing a large force acting on the first and second braking elements 58, 58a, 58b, 60, 60a in order to generate a large braking force acting on the drive shaft 44.

In the case of an elevator system 10 comprising a small elevator car 12 only a comparatively small braking force is needed. Thus, the elevator brake 50 of said elevator system 10 may be provided with a smaller number of actuators 70. By employing a smaller number of actuators 70, the costs and the efforts for manufacturing and maintaining the elevator brake 50 may be reduced.

It is to be noted that an elevator brake 50 comprising a small number of actuators 70, as well as an elevator brake 50 comprising a large number of actuators 70 may be produced from the same components. Thus, these components may be produced in large numbers to be used in different types elevator brakes 50, in particular different types elevator brakes 50 having different numbers of actuators 70. This will reduce the costs for producing the elevator brakes 50 even further.

If a plurality of actuators 70 are employed, it might be beneficial to arrange and actuate the actuators 70 symmetrically with respect to the axis A for generating a symmetric braking force acting on the first and second braking elements 58, 58a, 58b, 60, 60a in order to avoid any imbalance of the rotating first and second braking elements 58, 58a, 58b, 60, 60a.

In the special case of using an even number of actuators 70, it might be beneficial to arrange the actuators 70 pairwise on a common line extending through the axis A and to simultaneously activate the actuators 70 of such a pair in order to generate a symmetric braking force acting on the first and second braking elements 58, 58a, 58b, 60, 60a.

### Further Embodiments:

A number of optional features are set out in the following. These features may be realized in particular embodiments, alone or in combination with any of the other features.

In an embodiment the at least two actuators are operable independently of each other. This allows to sequentially activate and deactivate the actuators of the brake. As a result, the braking force provided by the brake may be progressively decreased/increased in order to progressively disengage/engage the brake, and an abrupt stopping or starting of movement of the elevator car, which may be uncomfortable or even dangerous for passengers residing inside the elevator car, may be avoided.

In an embodiment the elevator brake is a safety-brake, i.e. the brake is in an engaged condition when the at least two actuators are not operated and thus are inactive.

In an embodiment the at least two actuators have an identical or at least a similar structure. Using actuators having an identical or at least a similar structure allows to use a large number of identical components for each of the actuators. This helps to reduce the costs for producing the actuators.

In an embodiment each actuator comprises at least one elastic element, which in particular is configured for activating the brake, and/or at least one electromagnetic device, which in particular is configured for deactivating/releasing the brake. A configuration comprising an elastic element, which in particular is configured for activating the brake, and/or an electromagnetic device, which in particular is configured for deactivating/releasing the brake, provides a simple but reliable mechanism for operating the brake. Particularly, such configuration allows to construct a fail-safe brake as referred to above.

In an embodiment the at least one electromagnetic device comprises an electric coil and a rod, which is movable by activating and deactivating the electric coil. The elastic element in particular may be configured for moving the rod in a first direction, when the electric coil is not activated, and the electromagnetic device may be configured for moving the rod in a second, opposite direction, when activated. Such a configuration provides a simple but reliable mechanism for operating the brake. In particular such configuration allows to provide a brake which is activated for braking by means of the elastic element when the electric coil is deactivated. Such a configuration provides a fail-safe or safety brake which is braking even in an emergency situation when no electrical power is available.

In an embodiment at least one second braking element is attached to a rotating drive shaft such that any rotational movement between the at least one second braking element and the drive shaft is prevented, but a relative movement of the at least one second braking element with respect to the drive shaft in the axial direction is possible. In consequence, the at least one second braking element attached to the drive shaft rotates integrally with the axis, and a braking force acting on the at least one second braking element will be transferred to the drive shaft. The braking force may be applied by moving the second braking element(s) in the axial direction in order to abut against at least one first, non-rotating braking element.

In an embodiment the at least one second braking element is attached to the drive shaft by means of a plurality of teeth formed on an inner periphery of the at least one second braking element and on an outer periphery of the drive shaft, respectively. Engaging teeth provide a reliable spline connection between the second braking element(s) and the drive shaft allowing a relative movement in the axial direction but preventing any relative movement in the rotational direction.

In an embodiment at least one first braking element is attached to a housing for preventing any rotational movement between the at least one first braking element and the housing, but allowing a relative movement of the at least one first braking element with respect to the housing in the axial direction. In consequence, as the at least one first braking element is not capable to rotate with respect to the housing, it may provide a rotational braking force to abutting second braking elements.

In an embodiment the at least one first braking element is attached to the housing by means of a plurality of teeth formed on an outer periphery of the at least one first braking element engaging with a plurality of teeth formed on an inner periphery of the housing. Such a configuration comprising engaging teeth provides a reliable spline connection between the first braking element(s) and the housing allowing a relative movement in the axial direction but preventing any movement in the rotational direction.

In an embodiment the braking elements are provided as discs, in particular as discs having a circular shape. Circular discs, in particular circular discs comprising inner or outer teeth, which are configured for engagement with corresponding teeth formed on a drive shaft or an inner circumference of the housing, are easy to produce.

In an embodiment the actuators are arranged on a circle which is centered around the axial direction for symmetrically acting on the braking elements in order to cause a linear movement of the braking elements without any inclination or shear stresses caused by the actuators.

In an embodiment the elevator brake comprises a plurality of actuators which are arranged and actuated symmetrically with respect to the axis. The actuators in particular may be spaced apart from each other equidistantly in the circumferential direction, i.e. with the angle between two adjacent actuators with respect to the center of the braking elements being constant.

Such a configuration allows the actuators to symmetrically impact on the braking elements in order to avoid any imbalances caused by asymmetric forces acting on the braking elements. Selectively activating only some but not all of the plurality of pairs of braking elements allows to adjust the actually acting braking force(s) in order to meet the actual needs. It further allows to engage and disengage the brake progressively. Progressively engaging and disengaging the brake enhances the riding comfort of passengers residing within the elevator car; it further improves the braking performance in particular at higher rotational speeds.

In an embodiment two actuators are arranged at an angular distance of 180° with respect to each other allowing to symmetrically act on the braking elements in order to avoid any imbalance which might be caused by asymmetric forces acting on the braking elements.

Furthermore, only a reduced number of the electric coils may be activated for test purposes in order to ensure that the brake is capable of holding the maximum load and/or stopping the elevator car in an emergency situation even with a reduced number of actuators being active, as it is required by elevator safety codes.

In an embodiment the elevator brake comprises a plurality of braking elements arranged next to each other along the axial direction. This reduces the pressures and forces acting on each of the braking elements and thus contributes to minimizing negative effects of hard and/or frequent braking operations, such as fading.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the claims.

### REFERENCES

10 elevator system
12 elevator car
14 counterweight
16 tension members
20 elevator hoist machine
22 position encoder
23 limit switch
24 controller
40 motor
44 drive shaft
46 sheave
48 traction surfaces
50 elevator brake
51 front plate
52 housing of the elevator brake
53 fastening lug
54 tubular portion of the housing
55 fastening opening
56 inner teeth of the housing
58, 58a, 58b first braking element
59 external teeth
60, 60a second braking element
61 circumferential opening
62 cover plate
64 rod
66 elastic element
68 housing of the actuator
70 actuator
72 electric coil
A central axis
HW hoistway
L1, L2, L3 landings

1. Elevator brake (50) comprising:
at least one first braking element (58, 58a, 58b) and at least one second breaking element (60, 60a) extending parallel to each other orthogonally to a common axial direction and being movable with respect to each other in said axial direction; and
at least two actuators (70), which are arranged in a circumferential direction and configured for moving at least one of the first and second braking elements (58, 58a, 58b, 60, 60a) in the axial direction.

2. Elevator brake (50) of claim 1, wherein the at least two actuators (70) have an identical or at least a similar structure.

3. Elevator brake (50) of claim 1, wherein the at least two actuators (70) are operable independently of each other.

4. Elevator brake (50) of claim 1, wherein each actuator (70) comprises at least one elastic element (66), which in particular is configured for activating the elevator brake (50), and at least one electromagnetic device, which in particular is configured for releasing the elevator brake (50), wherein the at least one electromagnetic device in particular comprises an electric coil (72) and a rod (64) which is movable by activating and deactivating the electric coil (72).

5. Elevator brake (50) of claim 1, wherein at least one second braking element (60, 60a) is attached to a rotating drive shaft (44) for preventing any rotational movement between the second braking element (60, 60a) and the drive shaft (44), but allowing a movement of the at least one second braking element (60, 60a) with respect to the drive shaft (44) in the axial direction.

6. Elevator brake (50) of claim 5, wherein the at least one second braking element (60, 60a) is attached to the drive shaft (44) by means of a plurality of teeth formed on an inner periphery of the at least one second braking element (60, 60a) and on an outer periphery of the drive shaft (44), respectively.

7. Elevator brake (50) of claim 1, wherein at least one first braking element (58, 58a, 58b) is attached to a housing (52) for preventing any rotational movement between the at least one first braking element (58, 58a, 58b) and the housing (52), but allowing a relative movement of the at least one first braking element (58, 58a, 58b) with respect to the housing (52) in the axial direction.

8. Elevator brake (50) of claim 7, wherein the at least one first braking element (58, 58a, 58b) is attached to the housing (52) by engaging a plurality of external teeth (59) formed on an outer periphery of the at least one first braking element (58, 58a, 58b) with a plurality of inner teeth (56) formed on an inner periphery of the housing (52).

9. Elevator brake (50) of claim 1, wherein the first and second braking elements (58, 58a, 58b, 60, 60a) are formed as discs, the discs in particular having a circular shape.

10. Elevator brake (50) of claim 1 any of the preceding claims, wherein the actuators (70) are arranged on a circle centered around the axial direction.

11. Elevator brake (50) of claim 1, wherein the actuators (70) are equidistantly spaced apart from each other in the circumferential direction, and/or wherein the actuators (70) are arranged and actuated symmetrically with respect to the axis A.

12. Elevator brake (50) of claim 1, comprising a plurality of first and second braking elements (58, 58a, 58b, 60, 60a) arranged next to each other along the axial direction.

13. Elevator system (10) comprising a movable elevator car (12), at least one tension member (16) for suspending the elevator car (12), a motor (40) for driving the tension member (16) and/or the elevator car (12), and an elevator brake (50) according to claim 1 for braking the tension member (16) and/or the elevator car (12).

14. Method of releasing an elevator brake (50) comprising:
at least one first braking element (58, 58a, 58b) and at least one second breaking element (60, 60a) extending parallel to each other orthogonally to a common axial direction and being movable with respect to each other in said axial direction; and
at least two actuators (70), which are arranged in circumferential direction with respect to the axis and configured for moving at least one of the first and second braking elements (58, 58a, 58b, 60, 60a) in the axial direction;
wherein the method comprises activating at least one of the actuators (70), wherein the method in particular comprises activating at least one of the actuators (70) in a first step and activating at least one additional actuator (70) in a second step.

15. Method of activating an elevator brake (50) comprising:
at least one first braking element (58, 58a, 58b) and at least one second breaking element (60, 60a) extending parallel to each other orthogonally to a common axial direction and being movable with respect to each other in said axial direction; and
at least two actuators (70), which are arranged in in circumferential direction with respect to the axis and configured for moving at least one of the first and second braking elements (58, 58a, 58b, 60, 60a) in the axial direction;
wherein the method comprises deactivating at least one of the actuators (70), wherein the method in particular comprises deactivating at least one of the actuators (70) in a first step and deactivating at least one additional actuator (70) in a second step.
